(19) United States
(12) Patent Application Publication
(10) Pub. No.: US 2015/0371413 A1
(43) Pub. Date: Dec. 24, 2015

(54) DEVICE AND METHOD FOR CHANGING COLOR OF TEXT DISPLAYED ON DISPLAY DEVICE

(71) Applicant: Jae-Hyun BAHK, Gumi-si, Gyeongsangbuk-do (KR)

(72) Inventor: Jae-Hyun BAHK, Gumi-si (KR)

(21) Appl. No.: 14/762,808

(22) PCT Filed: Jan. 23, 2014
(86) PCT No.: PCT/KR2014/000671

§ 371 Date: Jul. 23, 2015

(30) Foreign Application Priority Data
Jan. 23, 2013 (KR) 10-2013-0007345

(51) Int. Cl. G06T 11/00; G06F 3/0484; G06T 11/60

(52) U.S. Cl. CPC G06T 11/001; G06T 11/60; G06F 3/04842

(57) ABSTRACT

Disclosed are a device and method for changing the color of text displayed on a display device, which enable the color of the text, a picture or the like displayed on the display device to be easily changed through a simple input of a user. The device for changing the color of text displayed on a display device comprises: receiving and setting the color of text to be changed on the display device; receiving a user input for changing the color; recognizing a position at which the input for changing the color of the text is inputted and determining a color change region according to the position; and changing the color of the text in the color change region to the color set in the setting the color of text.

### TECHNICAL FIELD

The present invention relates generally to a device and method for changing color of text displayed on a display device and, more particularly, to a device and method for changing color of text displayed on a display device, which enables the color of text, a graphic or the like displayed on a display device to be easily changed by simple input by a user.

### BACKGROUND

Recently, devices such as electronic whiteboards, tablet Personal Computers (tablet PCs), or smart phones that use keyboards or exclusive pads for text input or touch screen technologies to directly input text or a graphic in areas touched by the user on a display screen have become widespread.

In order to change the color of text or graphics displayed on a display device employed by the device, a method of inputting or writing text or a graphic after setting a desired color through the settings menu or settings window is used. Accordingly, if the color of text or a graphic is to be changed after the text or graphic is input or written to be displayed on the display device, all of the text or graphics has to be deleted and new text or graphics has to be input or written after the color is set again using the settings menu or settings window, which causes inconvenience. Especially, in such a conventional method, if the user often tries to change the color of the displayed text or graphic, the user has to repeat the color setting procedure using the settings menu or settings window every time, and accordingly, problems arise that the color change is very burdensome and it takes much more time than necessary to input or write text or a graphic.

### SUMMARY OF THE INVENTION

Accordingly, the present invention has been made keeping in mind the above problems occurring in the prior art, and an object of the present invention is to provide a device and method for changing color of text displayed on a display device, by which a user can easily change the color of text or a graphic in a desired area through a simple user input even after the user displays the text or graphic on the display device.

In order to accomplish the above object, the present invention provides a device for changing color of text displayed on a display device, the device includes a display device for visually presenting text; a display controller for recognizing a position of text displayed on the display device, recognizing a position where an input for color change is made, and controlling the display device to change the color of the displayed text to a preset color according to a relationship between the position of the displayed text and the position Where the input for color change is made; and an input unit for receiving the input for color change from a user.

The display controller may include a color setting unit for setting a color to be changed according to the input for color change; a region determiner for determining a color change region in which color is changed, by recognizing a position where the input for color change is made; and a color changing unit for controlling the display device to change the color of the displayed text included in the color change region determined by the region determiner.

The area determiner may be configured to receive a preset color change pattern as the input for color change, and determine the color change region according to a position of the preset color change pattern.

The area determiner may be configured to recognize a single letter, word, letter string, sentence or paragraph that exists under the color change pattern and determine a region that includes the recognized single letter, word, letter string, sentence or paragraph as the color change region.

The area determiner may be configured to receive at least two or more of the color change pattern, recognize a single letter, word, letter string, sentence or paragraph that exists between the two or more of the color change pattern, and determine a region that includes the recognized single letter, word, letter string, sentence or paragraph as the color change region.

The area determiner may be configured to receive a color change line as the input for color change, and set the color change region according to whether the color change line overlaps the region of the displayed text.

The area determiner may be configured to recognize text having a region, a part of which overlaps the color change line, and set the recognized text to be the color change region.

The area determiner may be configured to recognize a single curve having a region that overlaps the color change line, and set the recognized single curve to be the color change region.

In order to accomplish the above object, the present invention also provides a method for changing color of text displayed on a display device, the method includes receiving and setting a color of text to be changed on the display device; receiving a user input to change color of text; recognizing, a position where the input for color change is made and determining a color change region in which the color of text displayed on the display device is to be changed, based on the position where the input for color change is made; and changing the color of the text in the color change region to the set color.

Determining a color change region may include determining whether the input for color change is a preset color change pattern or a color change line; and determining a color change region according to a position of the preset color change pattern if the input for color change is the preset color change pattern.

Determining a color change region may include recognizing a single letter, word, letter string, sentence or paragraph that exists adjacent to the color change pattern and determining a region that includes the recognized single letter, word, letter string, sentence or paragraph as the color change region.

Determining a color change region may include receiving at least two of more of the color change pattern, recognizing a single letter, word, letter string, sentence or paragraph that exists between the two or more of the color change patterns, and determining a region that includes the recognized single letter, word, letter string, sentence or paragraph as the color change region.

Determining a color change region may include determining whether the input for color change is a preset color change pattern or a color change line; and setting the color change region according to whether the color change line overlaps the region of the displayed text, if the input for color change is the color change line.

Setting a color change region may include recognizing text having a region, a part of which overlaps the color change line, and setting the recognized text to be the color change region.

Setting a color change region may include recognizing a single curve that has a region overlapping the color change line, and setting the recognized single curve to be the color change region.

According to the present invention, if the color of text or a graphic having already been displayed or written on a display device is to be changed, the color of the text or graphic may be changed into a desired color through a simple input from the user without a need for rewriting the text or graphic in the desired color.

Furthermore, according to the present invention, the color of text or a graphic may be accurately and easily changed even after the text or graphic is displayed on a display device, and thus user may more conveniently deliver a variety of different information using the display device, for example, lectures, promotional information, exhibition information, etc.

### BRIEF DESCRIPTION OF THE DRAWINGS

FIG. 1 is a block diagram illustrating a device for changing color of text displayed on a display device, according to an embodiment of the present invention;

FIG. 2 is a flowchart illustrating a method for changing color of text displayed on a display device, according to an embodiment of the present invention;

FIG. 3 is a detailed block diagram illustrating operation of determining a color change region in the method for changing color of text displayed on a display device in accordance with the embodiment of the present invention as shown in FIG. 2; and

FIGS. 4 to 7 illustrate examples of color change performed by a device and method for changing color of text displayed on a display device, according to an embodiment of the present invention.

### DETAIL DESCRIPTION OF THE INVENTION

Reference should now be made to the drawings, in which the same reference numerals are used throughout the different drawings to designate the same or similar components. This invention may, however, be embodied in many different forms and should not be construed as limited to the embodiments set forth herein. Rather, these embodiments are provided so that this invention will be thorough and complete, and will fully convey the scope of the invention to those skilled in the art. Terminologies as herein used are defined by taking into account corresponding functionalities in the present invention, which may depend on the custom or intention of people skilled in the art, and thus, should not be construed to restrict the technical components of the present invention.

The term ‘text’ in particular, as herein used should not be interpreted literally, but should be interpreted as having a meaning that includes text, a graphic, or other various forms displayed on a display device through the user's input or composition.

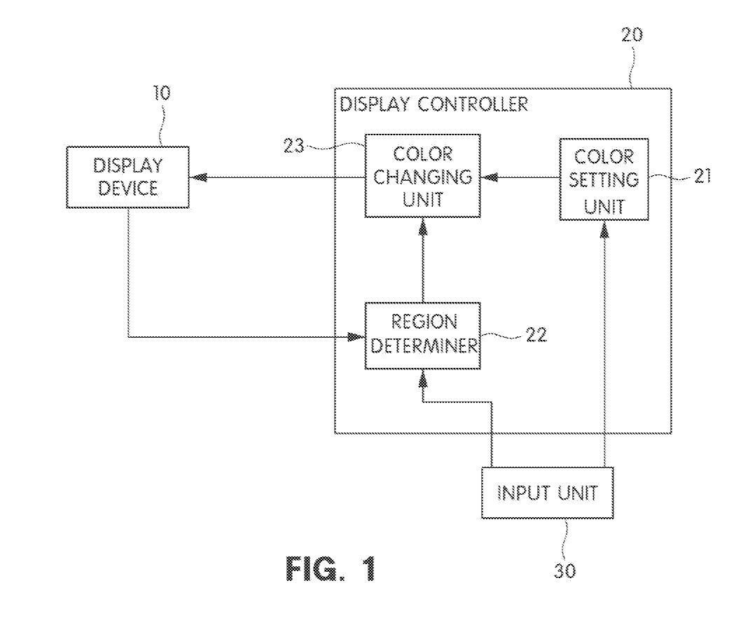

FIG. 1 is a block diagram illustrating a device for changing color of text displayed on a display device, according to an embodiment of the present invention.

As shown in FIG. 1, a device for changing color of text displayed on a display device in accordance with an embodiment of the present invention may be configured to largely include a display device 10, a display controller 20, and an input unit 30.

The display device 10 is a device for displaying contents input by the user through the input unit 30, Which visually presents text or a graphic input or written by the user through various input means. The display device 10 may be implemented with various types of display means widely known in the art. For example, the display device 10 may be implemented with a Liquid Display Panel (LCD), an Organic Light Emitting Display (OLED) panel, a Plasma Display Panel (PDP), a beam projector, or the like.

The display controller 20 may basically control the display device 10 to display contents that correspond to what are input by the user through the input unit 30. In an embodiment of the present invention, the display controller 20 may recognize a position Where the text or graphic is displayed on the display device 20, recognize a position where an input for color change is made by the user through the input unit 30, and control the display device 10 to change the color of the displayed text or graphic to a preset color based on a relationship between the position of the displayed text or graphic and the position where the input for color change is made.

More specifically, the display controller 20 may include a color setting unit 21 for setting a replacement color according to a color change input made by the user through the input unit 30, a region determiner 22 for determining a region where the color is to be changed by recognizing a position where the text or graphic is displayed on the display device 20 and a position where the input for color change is made by the user through the input unit 30, and a color changing unit 23 for controlling the display device 10 to change the color of the displayed text or graphic included in the color change region determined by the region determiner 22.

The input unit 30 is a means for receiving text or a graphic that the user wants to display on the display device 10 as an input, or for receiving a color change input for changing the color of the text or graphic displayed on the display device 10 from the user. The input unit 30 may employ various types of input devices widely known in the art, for example, a mouse, a keyboard, a touch screen, or the like.

The present invention also provides a color changing method implemented by the aforementioned device for changing color of text displayed on a display device.

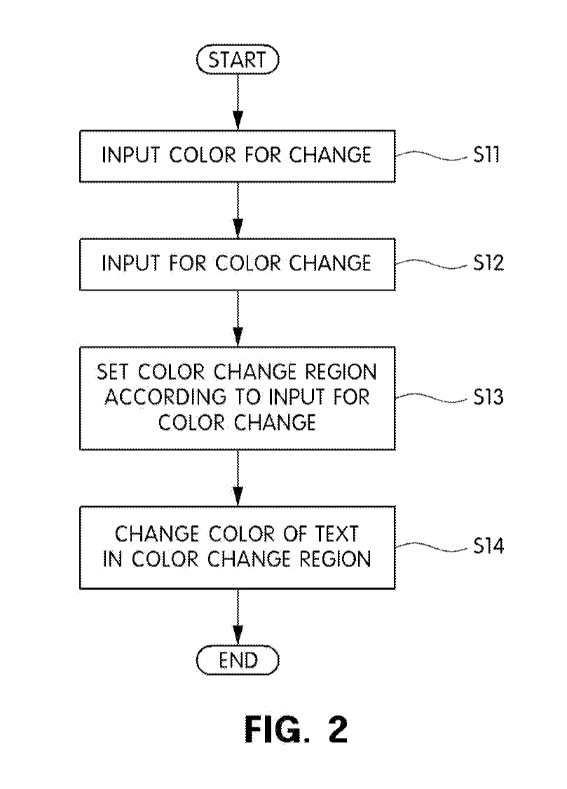

FIG. 2 is a flowchart illustrating a method for changing color of text displayed on a display device, according to an embodiment of the present invention.

Referring to FIG. 2, a method for changing color of text displayed on a display device in accordance with an embodiment of the present invention may include receiving and setting a color of text to be changed on the display device 10, in operation S11; receiving a user input to change a color of text through the input unit 30, in operation S12; recognizing, by the display controller 20, a position where the input for color change is made and determining a color change region in which the color of text displayed on the display device is to be changed, based on the position where the input for color change is made, in operation S13; and changing, by the display controller 20, the color of the text in the color change region to the set color, in operation S14.

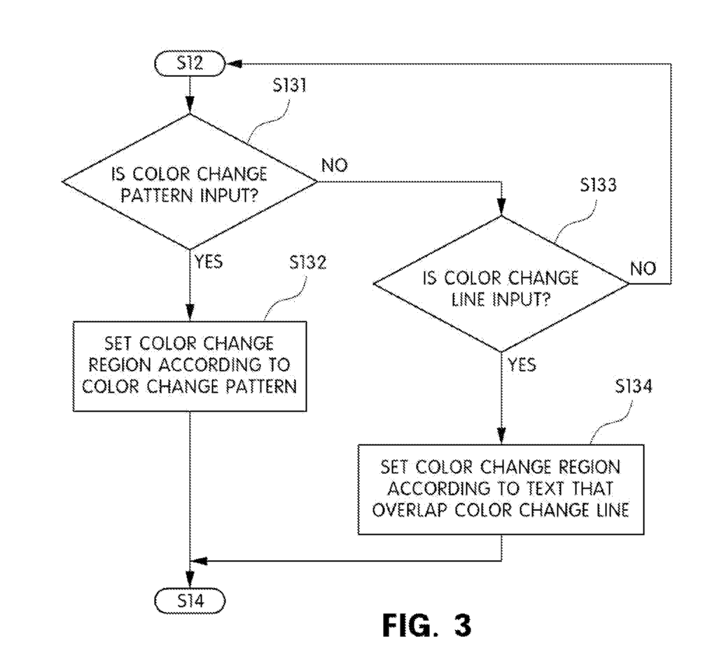

FIG. 3 is a detailed block diagram illustrating operation of determining a color change region in the method for changing color of text displayed on a display device in accordance with the embodiment of the present invention as shown in FIG. 2.

Referring to FIG. 3, in an embodiment of the present invention, the operation S13 of determining the color change region ma include determining, by the region determiner 22 of the display controller 20, whether the input for color change is a preset color change pattern or a preset color change line, in operations S131, S133, and determining, by the region determiner 22, a color change region according to the preset color change pattern, if it is determined that the input for color change is the preset color change pattern, in operation S132.

In another embodiment of the present invention, the operation S13 of determining the color change region may include determining, by the region determiner 22 of the display controller 20, whether the input for color change is a preset color change pattern or a preset color change line, in operations S131, S133, and setting, by the region determiner 22, the color change region according to whether the color change line overlaps a region of the displayed text, if it is determined that the input for color change is the preset color change line, in operation S134.

Operation and effects of a device and method for changing color of text displayed on a display device in accordance with an embodiment of the present invention will now be described in detail.

Operation of the device for changing color of text displayed on a display device in accordance with the embodiment of the present invention begins with operation S11 in which the user sets a color of text to be changed on the display device 10 through the input unit 30. Text or a graphic, which is a target for color change, is displayed on the display device 10, and the user may input a target color to be replaced for the color of the displayed text or graphic through the input unit 30. Upon receiving a color setting input from the user through the input unit 30, the display controller 21 may set the color input from the color setting unit 21 to the target color for replacement.

The user may then provide an input to the display controller 23 through the input unit 30 to perform color change. While text or a graphic input or written by the user in advance and subject to color change is displayed on the display device 10, the user may provide an input to change the color of the text displayed on the display device 10 by manipulating the input unit 30, and the user input for color change is delivered to the range determiner 22 of the display controller 20.

The range determiner 22 may then recognize a position where the text or graphic to be changed in color is displayed on the display device 10 and a position where the input for color change is made by the user, and accordingly, set a color change region, in operation S13.

According to the user input for color change, operation of the region determiner to set a color change region may be performed in various methods, and a method illustrated in FIG. 3 may be applied as a desirable example.

In FIG. 3, an example where the region determiner 22 recognizes a particular pattern input by the user and sets a color change region according to a position where the particular pattern is input, and another example of setting a color change region according to a color change line drawn by the user over the displayed text or graphic are shown.

In order to set a color change region, the region determiner 22 first determines whether the user input for color change is a color change pattern or a color change line, in operations S131, S133. While FIG. 3 shows a sequence of determining if it is a color change pattern in operation S131 and then determining if it is a color change line in operation S133, it is only by way of example to conveniently illustrate how to set a color change region in a drawing, and the sequence may naturally change.

If the region determiner 22 determines that the input for color change is a color change pattern, the region determiner 22 may recognize a position of the color change pattern, and set a color change region according to the position of the color change pattern, in operation S117.

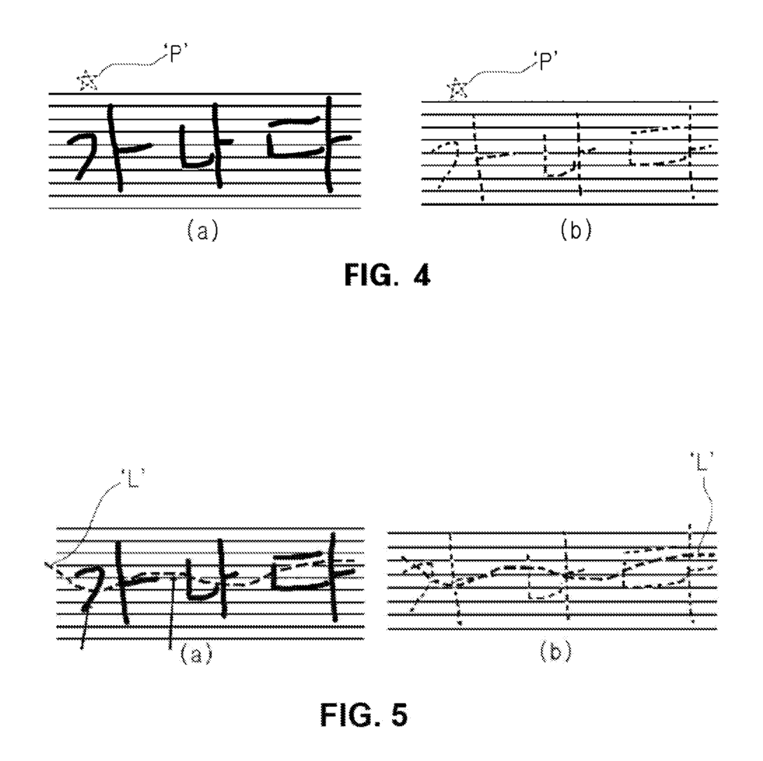

FIG. 4 illustrates examples of setting a color change region and changing color of the displayed text, which are performed by the region determiner, if a color change pattern is input.

As shown in (a) of FIG. 4, the region determiner 22 may recognize a position of color change pattern P that is displayed above a part of the displayed text, and set a region that includes the text below the position where the color change pattern P is recognized, as a color change region. Subsequently, as shown in (b) of FIG. 4, the text in the color change region may change into a color (blue in FIG. 4) set by the color setting unit 21 under control of the color changing unit 23.

A character recognition technology may be applied in setting a color change region by the region determiner 22. According to a character recognition technology currently known, letters, words, letter strings, sentences, paragraphs, etc., may be distinguished and identified. Such a character recognition algorithm may be applied in the region determiner 22, and if the color change pattern P is input, a single letter, word, letter string, sentence or paragraph that has been displayed and is located adjacent to the color change pattern (plainly below the color change pattern) is recognized by the character recognition algorithm, and the recognized single letter, word, letter string, sentence or paragraph may then be determined as a color change region.

While FIG. 4 shows a star (⋆) used as an example of the color change pattern P, the color change pattern P may be set in advance to have any of various forms, such as an asterisk (*), a reference mark (), etc. Especially, a replacement color may be set in advance for each form of the color change pattern P. For example, the color setting unit 21 may be configured to change the text included in the color change region into blue, red, and yellow if a star, an asterisk, and a reference mark are used as the color change pattern, respectively. In this case, the region determiner 22 may provide the color changing unit 23 with information about a form of the color change pattern, and the color changing unit 23 may determine from the color setting unit 21 a color to correspond to the color change pattern and change the color of the text displayed on the displayed device 10.

In the meantime, although not specifically illustrated, in the example of using the color change pattern, the region determiner 22 may set the color change region by receiving two or more color change patterns from the user. In this case, the area determiner 22 may recognize a single letter, word, letter string, sentence or paragraph that exists between the two or more color change patterns, and determine a region including the recognized single letter, word, letter string, sentence, or paragraph as the color change region.

If the region determiner 22 determines that the input for color change is a color change line, the region determiner 22 may recognize a position of the color change line, and set a color change region according to the position of the text that overlaps the color change line, in operation S134.

FIG. 5 illustrates examples of setting a color change region and changing color of the displayed text, which are performed by the region determiner, if a color change line is input.

As shown in (a) of FIG. 5, the region determiner 22 may recognize a position of color change line L and a position of the displayed text, and set a color change region according to whether the color change line L overlaps a region of the displayed text. Subsequently, as shown in (a) of FIG. 5, the displayed text having a part that overlaps the color change line L may then change into a color (red in FIG. 5) set by the color setting unit 21 under control of the color changing unit 23.

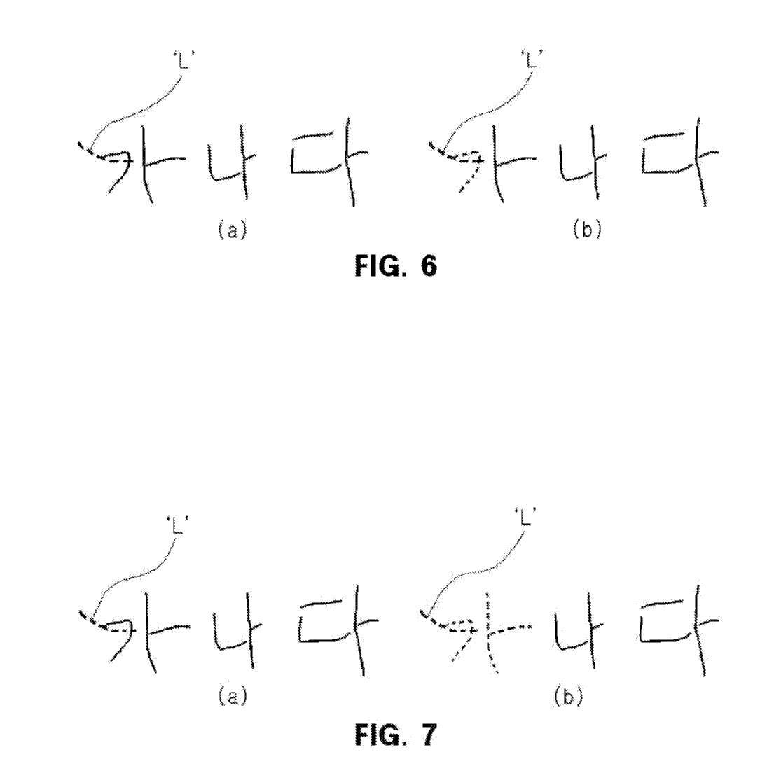

FIGS. 6 and 7 show specific examples of setting a color change region and changing a color using the color change line L.

FIG. 6 shows an example of setting a single curve (a continuous curve without broken parts) having, a region that overlaps a color change line as a color change region and performing color change. As shown in (a) of FIG. 6, in a case that the color change line L overlaps only part ‘ [symbol] ’ of letter ‘ [symbol] ’, the region determiner 22 may set only the part ‘ [symbol] ’, which is a single curve having a part that the color change line L overlaps, to be a color change region, and allow color change to be performed in the color change region as shown in (b) of FIG. 6.

FIG. 7 shows an example of setting an entire letter, a part of which overlaps the color change line, as a color change region and performing color change on the letter. Similar to (a) of FIG. 6, as shown in (a) of FIG. 7, in a case that the color change line L overlaps only part ‘ [symbol] ’ of letter ‘ [symbol] ’, the region determiner 22 may recognize the letter ‘ [symbol] ’ including the part ‘ [symbol] ’ through a character recognition algorithm, set the single letter to be a color change region, and allow color change to be performed in the color change region as shown in (b) of FIG. 7.

Such methods for setting a color change region according to a color change line may be set in advance by the user.

After setting the color change region as described above, color change may actually be performed by the color changing unit 23 of the display controller 20 on the text within the color change region, in operation S14. The color changing unit 23 may receive information about a color change region input by the region determiner 22 and information about a replacement color input by the color setting unit 21, to change the text or graphic within the color change region into the set color. The color changing method may be determined depending on the type of the display device 10, and may mainly operate in a way to drive the display device 10 such that an output color of pixels corresponding to the displayed text or graphic within the color change region is changed to a set color.

As described above, in an embodiment of the present invention, if the color of text or graphic being, already displayed or written on a display device is to be changed, the color of the text or graphic can be changed to a desired color through a simple input from the user without separately rewriting the text or graphic in the desired color. That is, in the embodiment of the present invention, color change of text or graphic is easily enabled even after the text or graphic is displayed on a display device, which helps a user to more conveniently deliver a variety of different information using a display device, for example, lectures, promotional information, exhibition information, etc.

Several embodiments have thus been described, but it will be understood that various modifications can be made without departing the scope of the present invention. Thus, it will be apparent to those ordinary skilled in the art that the invention is not limited to the embodiments described, but can encompass not only the appended claims but the equivalents.

1. A device for changing color of text displayed on a display device comprising:
a display device for visually presenting text;
a display controller for recognizing a position of text displayed on the display device, recognizing a position where an input for color change is made, and controlling the display device to change the color of the displayed text to a preset color according to a relationship between the position of the displayed text and the position where the input for color change is made; and
an input unit for receiving the input for color change from a user.

2. The device for changing color of text displayed on the display device of claim 1, wherein the display controller comprises:
a color setting unit for setting a color to be changed according to the input for color change;
a region determiner for determining a color change region in which color is changed, by recognizing a position where the input for color change is made; and
a color changing unit for controlling the display device to change the color of the displayed text included in the color change region determined by the region determiner.

3. The device for changing color of text displayed on the display device of claim 2, wherein the area determiner is configured to receive a preset color change pattern as the input for color change, and determine the color change region according to a position of the preset color change pattern.

4. The device for changing color of text displayed on the display device of claim 3, wherein the area determiner is configured to recognize a single letter, word, letter string, sentence or paragraph that exists under the color change pattern and determine a region that includes the recognized single letter, word, letter string, sentence or paragraph as the color change region.

5. The device for changing color of text displayed on the display device of claim 3, wherein the area determiner is configured to receive at least two or more of the color change pattern, recognize a single letter, word, letter string, sentence or paragraph that exists between the two or more of the color change patterns, and determine a region that includes the recognized single letter, word, letter string, sentence or paragraph as the color change region.

6. The device for changing color of text displayed on the display device of claim 2, wherein the area determiner is configured to receive a color change line as the input for color change, and set the color change region according to whether the color change line overlaps the region of the displayed text.

7. The device for changing color of text displayed on the display device of claim 6, wherein the area determiner is configured to recognize text having a region, a part of which overlaps the color change line, and set the recognized text to be the color change region.

8. The device for changing color of text displayed on the display device of claim 6, wherein the area determiner is configured to recognize a single curve having a region that overlaps the color change line, and set the recognized single curve to be the color change region.

9. A method for changing color of text displayed on a display device comprising:
receiving and setting a color of text to be changed on the display device;
receiving a user input to a change color of text;
recognizing a position where the input for color change is made and determining a color change region in which the color of text displayed on the display device is to be changed, based on the position where the input for color change is made; and
changing the color of the text in the color change region to the set color.

10. The method for changing color of text displayed on the display device of claim 9, wherein the determining the color change region comprises:
determining whether the input for color change is a preset color change pattern or a color change line; and
determining a color change region according to a position of the preset color change pattern if the input for color change is the preset color change pattern.

11. The method for changing color of text displayed on the display device of claim 10, wherein the determining the color change region comprises:
recognizing a single letter, word, letter string, sentence or paragraph that exists adjacent to the color change pattern and determining a region that includes the recognized single letter, word, letter string, sentence or paragraph as the color change region.

12. The method for changing color of text displayed on the display device of claim 10, wherein the determining the color change region comprises:
receiving at least two or more of the color change pattern, recognizing a single letter, word, letter string, sentence or paragraph that exists between the two or more of the color change pattern, and determining a region that includes the recognized single letter, word, letter string, sentence or paragraph as the color change region.

13. The method for changing color of text displayed on the display device of claim 9, wherein the determining the color change region comprises:
determining whether the input for color change is a preset color change pattern or a color change line; and
setting the color change region according to whether the color change line overlaps the region of the displayed text, if the input for color change is the color change line.

14. The method for changing color of text displayed on the display device of claim 13, wherein the setting the color change region comprises:
recognizing text having a region, a part of which overlaps the color change line, and
setting the recognized text to be the color change region.

15. The method for changing color of text displayed on the display device of claim 13, wherein the setting the color change region comprises:
recognizing a single curve that has a region overlapping the color change line, and
setting the recognized single curve to be the color change region.
